(19) United States
(12) Patent Application Publication
(10) Pub. No.: US 2023/0290950 A1
(43) Pub. Date: Sep. 14, 2023

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventor: Mijung JUNG, Yongin-si (KR)

(21) Appl. No.: 18/178,144

(22) Filed: Mar. 3, 2023

(30) Foreign Application Priority Data
Mar. 11, 2022 (KR) 10-2022-0030851

(51) Int. Cl. H01M 4/62; H01M 10/052; H01M 4/587

(52) U.S. Cl. CPC H01M 4/62; H01M 10/052; H01M 4/587; H01M 2004/027

(57) ABSTRACT

Disclosed herein is a negative electrode for a rechargeable lithium battery and a rechargeable lithium battery including the same, wherein the negative electrode includes a current collector and a negative active material layer on at least one surface of the current collector, and the negative active material layer includes a negative active material and a microgel having a size of about 500 nm or less, and having porosity of about 27% to about 60%.

### CROSS-REFERENCE TO RELATED APPLICATION

This application claims priority to and the benefit of Korean Patent Application No. 10-2022-0030851 filed in the Korean Intellectual Property Office on Mar. 11, 2022, the entire contents of which are hereby incorporated by reference.

### BACKGROUND

### 1. Field

Embodiments of the present disclosure relate to a negative electrode for a rechargeable lithium battery and a rechargeable lithium battery including the same.

### 2. Description of the Related Art

With the rapid spread of electronic devices using batteries such as portable phones, laptop computers, and electric vehicles, demand for secondary batteries, which are small, lightweight and have relatively high capacity is rapidly increasing. For example, because a rechargeable lithium battery is lightweight and has high energy density, it is gaining the spotlight as a driving power for a portable device. Accordingly, research and development for improving the performance of a rechargeable lithium battery is actively being carried out.

To improve the energy density of the rechargeable lithium battery, thickening of an electrode having an increased thickness of an active material layer is being performed. However, thickening of an electrode may increase ion resistance, resulting in reduction or deterioration of high-rate characteristics.

The above information disclosed in this Background section is only for enhancement of understanding of the background of the present disclosure, and therefore it may contain information that does not form the prior art that is already known in this country to a person of ordinary skill in the art.

### SUMMARY

One or more embodiments provide a negative electrode for a rechargeable lithium battery which may effectively enable lithium-ion transportation to improve high-rate characteristics and cycle life characteristics.

Another embodiment provides a rechargeable lithium battery including the negative electrode.

One or more embodiments provide a negative electrode for a rechargeable lithium battery including a current collector and a negative active material layer on at least one surface of the current collector, wherein the negative active material layer includes a negative active material, and a microgel having a size of about 500 nm or less, and having a porosity of about 27% to about 60%.

The size of the microgel may be about 50 nm to about 500 nm.

The microgel may be in the form of a particle.

The microgel may include an acryl-based polymer.

The negative active material layer may include about 0.1 wt % or less, or about 0.05 wt % to about 0.1 wt % of the microgel based on the total weight of the negative active material layer.

Another embodiment provides a rechargeable lithium battery including the negative electrode, a positive electrode, and an electrolyte.

The negative electrode according to an embodiment may show excellent high-rate charging characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a drawing schematically illustrating a negative electrode for a rechargeable lithium battery according to one or more embodiments.

FIG. 2 is a drawing schematically illustrating a rechargeable lithium battery according to one or more embodiments.

FIG. 3 is a scanning electron microscope (SEM) image of a negative active material layer prepared according to Example 2.

FIG. 4 is a graph illustrating a mercury incremental intrusion according to the pore size of the negative electrode prepared according to Examples 1 and 2, Comparative Example 1, and Reference Example 1.

FIG. 5 is a graph illustrating the measured porosity of the negative electrode prepared according to Examples 1 and 2, Comparative Example 1, and Reference Example 1.

FIG. 6 is a graph illustrating charge rate capability according to charging constant current and constant voltage of a half-cell prepared according to Examples 1 and 2, Comparative Example 1, and Reference Example 1.

FIG. 7 is a graph illustrating charge rate capability according to charging constant current of the half-cell prepared according to Examples 1 and 2, Comparative Example 1, and Reference Example 1.

FIG. 8 is a graph illustrating electrochemical impedance spectroscopy (EIS) measured after charging and discharging the half-cell prepared according to Example 2 and Comparative Example 1.

### DETAILED DESCRIPTION

Hereinafter, embodiments of the present disclosure will be described in more detail. However, the embodiments are presented as examples, by which the subject matter of the present disclosure is not limited, and the subject matter of the present disclosure is defined only by the scope of the appended claims, and equivalents thereof.

The term “combination thereof,” as used herein, means a mixture of compositions, a laminate, a composite, a copolymer, an alloy, a blend, a reaction product, etc.

It will be further understood that the terms “comprise”, “having”, or “comprising,” when used in this specification, specify the presence of stated features, integers, steps, elements, or a combination thereof, but do not preclude the presence or addition of one or more other features, integers, steps, elements, or groups thereof.

In the drawings, the thickness of layers and regions may be exaggerated for clarity. Like reference numerals refer to like components throughout the specification. It will be understood that when an element such as a layer, film, region, or substrate is referred to as being “on” another element, it can be “directly on” the other element or intervening elements may also be present. In contrast, when an element is referred to as being “directly on” another element, there are no intervening elements present.

The term “thickness,” as used herein, may be measured through a photograph taken with an optical microscope such as a scanning electron microscope, for example.

Unless otherwise defined in this specification, the term “size,” as used herein, means a particle diameter. The term “particle diameter,” as used herein, refers to an average particle diameter (D50) indicating a diameter of a particle having an accumulated volume of 50 volume % in a particle size distribution. The average particle diameter (D50) may be measured by any suitable method generally used in the art. In some embodiments, the average particle diameter (D50) may be measured by, for example, by a particle size analyzer, and/or by a transmission electron microscope photograph and/or a scanning electron microscope photograph. As another method, the average particle diameter (D50) may be measured by analyzing data measured by a measuring device using a dynamic light-scattering method to count the number of particles for each particle size range and calculating an average value thereof.

A negative electrode for a rechargeable lithium battery according to one or more embodiments of the present disclosure includes a current collector and a negative active material layer on at least one surface of the current collector, wherein the negative active material layer may include a negative active material and a microgel having a size of about 500 nm or less, and having a porosity of about 27% to about 60%.

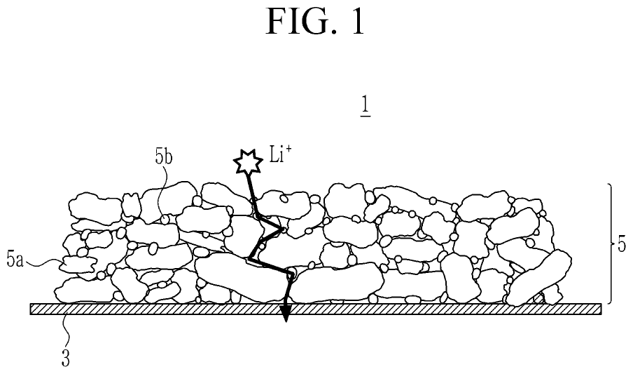

FIG. 1 illustrates a negative electrode (1) including a current collector (3) and a negative active material layer (5) on at least one surface of the current collector according to an embodiment.

A negative active material (5a) and a microgel (5b) may be included in the negative active material layer (5), and the microgel (5b) may function as a lithium-ion transportation passage.

Such a function of the lithium-ion transportation passage may be obtained from the microgel having a size of about 500 nm or less, as such a microgel may exhibit electrolyte-philic characteristics and improve porosity. For example, the microgel having a size of about 500 nm or less improves or increases porosity of the negative active material layer and facilitates movement of electrolyte and/or lithium ions through the negative active material layer. As the microgel having the size of about 500 nm or less functions as the lithium-ion transportation passage, high-rate charging characteristics may be improved. If the size of the microgel is greater than 500 nm, resistance (e.g., electrical resistance) of the polymer itself forming the microgel is increased, battery resistance is increased, and non-uniformity of the negative electrode surface may cause an increase in battery resistance (e.g., battery electrical resistance), which is not appropriate or desired.

In one or more embodiments, the size of the microgel may be about 50 nm to about 500 nm, or about 100 nm to about 500 nm.

The microgel may be in a particle form. For example, the microgel may be present in the negative active material layer in a particle form (e.g., may be present as a plurality of particles). In some embodiments, each particle of the microgel in the negative active material layer is in a sponge form, and is present in the negative active material in a particle form in which chains are entangled (e.g., in which chains of the microgel are entangled with each other), and is not present in a crushed form (e.g., the microgel is not present in a crushed form). In one embodiment, the sponge from indicates a porous form having holes and the crushed form indicates the difficultly in seeing the original shape or deconstructed from.

The porosity of the negative active material layer may be about 20% to about 60%, and may be about 20% to about 40%. When the porosity of the negative active material layer is less than 20%, the lithium-ion transportation effect is reduced, which is not appropriate or desired, and when the porosity of the negative active material layer exceeds 60%, negative electrode properties decrease and the energy density decreases, which is not appropriate or desired.

In one or more embodiments, the microgel may maintain a size of about 500 nm or less even after formation charging and discharging of the battery including the negative electrode including the microgel, which may be checked by scanning electron microscope (SEM) images taken of the negative electrode including the microgel after the formation charging and discharging.

In one or more embodiments, the negative active material layer may include about 0.1 wt % or less, or about 0.05 wt % to 0.1 wt % of the microgel based on the total weight 100 wt % of the negative active material layer. When the amount of the microgel is within the above range, the microgel may be uniformly distributed in the negative active material layer, thereby further reducing the resistance (e.g., electrical resistance), thus further improving high-rate charging characteristics.

The microgel may include an acryl-based polymer. The acryl-based polymer may be acrylic acid, polyacrylic acid, polyacrylamide, polyacrylonitrile, poly(methyl methacrylate), polymethacrylate, or a combination thereof.

In the negative electrode according to one or more embodiments, the negative active material includes a material capable of reversibly intercalating/deintercalating lithium-ion, a lithium metal, an alloy of a lithium metal, a material capable of doping and dedoping lithium, and/or a transition metal oxide.

The material capable of reversibly intercalating/deintercalating the lithium-ion may be a carbon material, and any suitable carbon-based negative active material generally used in the art in a lithium-ion secondary battery may be used. Crystalline carbon, amorphous carbon, or a combination thereof may be representative examples of the carbon-based negative active material. The crystalline carbon may be graphite such as unspecified shape (e.g., amorphous carbon), plate, flake, spherical, and/or fibrous natural graphite and/or artificial graphite, and the amorphous carbon (e.g., unspecified shape carbon) may be soft carbon, hard carbon, mesophase pitch carbide, and/or a sintered coke.

Lithium, and a metal alloy selected from the group consisting of Na, K, Rb, Cs, Fr, Be, Mg, Ca, Sr, Si, Sb, Pb, In, Zn, Ba, Ra, Ge, Al, and Sn may be used as the alloy of the lithium metal.

Examples of the material capable of doping and dedoping lithium may include Si, a Si-C composite, SiOx (0<x<2), Si-Q alloys (where Q is selected from alkali metals, alkali-earth metals, group 13 elements, group 14 elements, group 15 elements, group 16 elements, transition metals, rare earth elements, and combination thereof, but Q is not Si), Sn, SnO2, and Sn-R (where R is selected from alkali metals, alkaline earth metals, group 13 elements, group 14 elements, group 15 elements, group 16 elements, transition metals, rare earth elements, and combinations thereof, but R is not Sn). At least one selected from the foregoing or following materials may be mixed together with SiO_{2.} The elements Q and R may be independently selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof.

The Si-C composite may include silicon particles and crystalline carbon. The silicon particles may have an average particle diameter D50 of about 10 nm to about 200 nm. The Si-C composite may further include an amorphous carbon layer on at least a part thereof.

According to one or more embodiments, the negative active material layer may include a binder and may further include a conductive material (e.g., an electrically conductive material).

The negative active material layer may include about 94.9 wt % to about 97.9 wt % of the negative active material based on the total weight of the negative active material layer.

The negative active material layer may include about 1 wt % to about 5 wt % of the binder based on the total weight of the negative active material layer. The negative active material layer may include about 1 wt % to about 5 wt % of the conductive material based on the total weight of the negative active material layer.

The binder not only attaches the negative active material particles to each other but also adheres the negative active material to the current collector. The binder may include a non-water-soluble binder, a water-soluble binder, or a combination thereof.

Examples of the non-water-soluble binder may include an ethylene propylene copolymer, polyacrylonitrile, polystyrene, polyvinylchloride, carboxylated polyvinyl chloride, polyvinylfluoride, polyurethane, polytetrafluoroethylene, polyvinylidene fluoride, polyethylene, polypropylene, polyamideimide, polyimide, or combinations thereof.

Examples of the water-soluble binder may include styrene-butadiene rubbers (SBR), acrylated styrene-butadiene rubbers (ABR), acrylonitrile-butadiene rubbers, acrylic rubbers, butyl rubbers, fluorine rubbers, an ethylene oxide-containing polymer, polyvinylpyrrolidone, polypropylene, polyepichlorohydrin, polyphosphazene, an ethylene propylene diene copolymer, polyvinylpyridine, chlorosulfonated polyethylene, latex, polyester resin, acrylic resin, phenol resin, epoxy resin, polyvinyl alcohol, or combinations thereof.

When the water-soluble binder is used as the negative binder, a cellulose-based compound may be further used to provide viscosity as a thickener. The cellulose-based compound may include one or more of carboxymethyl cellulose, hydroxypropyl methylcellulose, methyl cellulose, or alkali metal salts thereof. The alkali metal may be Na, K, or Li. The thickener may be included in amount of about 0.1 to about 3 parts by weight based on 100 parts by weight of the negative active material.

The conductive material is used to provide electrode with conductivity (e.g., electrical conductivity). Any suitable electrically conductive material may be used as a conductive material as long as it does not cause a chemical change (e.g., an undesirable chemical change in the rechargeable lithium battery). Examples of the conductive material include carbon-based materials such as natural graphite, artificial graphite, carbon black, acetylene black, ketjen black, carbon fibers, and the like; metal-based materials such as metal powders or metal fibers including copper, nickel, aluminum, silver, and the like; conductive polymers such as polyphenylene derivatives; and mixtures thereof.

The current collector may include a copper foil, a nickel foil, a stainless steel foil, a titanium foil, a nickel foam, a copper foam, a polymer substrate coated with a conductive metal (e.g., an electrically conductive metal), or a combination thereof.

A negative electrode according to an embodiment may be prepared in a general procedure including preparing a negative active material layer composition in a slurry by mixing together a negative active material, a microgel, a binder, and optionally a conductive material (e.g., an electrically conductive material) in a solvent, coating it on a current collector, drying and pressurizing the composition.

The microgel may be prepared by the following process. An acrylic polymer, an amide-based compound, a base, and an oxidizing agent are mixed together in a solvent and the mixture is gelled. The gel is pulverized, ultrasonic wave treatment is performed, and then the resultant is filtered.

The amide-based compound serves as a crosslinker, and may be a diacrylamide-based polymer such as N,N′-methylenebisacrylamide and/or poly(ethylene glycol) diacrylamide, and/or the like. The base may be sodium hydroxide, lithium hydroxide, potassium hydroxide, or a combination of thereof. The oxidizing agent may be ammonium persulfate, potassium persulfate, or a combination thereof.

The solvent may be water, tetrahydrofuran, methanol, ethanol, or a combination thereof.

The acryl-based polymer, the amide-based compound, the base, and the oxidizing agent may be mixed together in a weight ratio of about 1:about 0.01 to about 0.5:about 0.3 to about 2:about 0.001 to about 0.3, or about 1:about 0.02 to about 0.2:about 0.4 to about 1:about 0.001 to about 0.1. When the mixing ratio of the acryl-based polymer, the amide compound, the base, and the oxidizing agent is within the foregoing ranges, if the prepared microgel is used for the negative active material layer, the microgel is contracted in the drying process during the preparation the negative active material layer, so that pores may be appropriately or suitably formed, and the shape of the microgel may be maintained, thereby obtaining an effect of including the microgel.

The gelation process may be performed by adding a catalyst, or by heat treatment under a non-catalyst.

An amine-based compound may be used as the catalyst, for example, tetramethylenediamine.

The heat treatment may be performed at about 50° C. to about 100° C. for about 1 hour to about 5 hours.

After the gelation process, a process of washing with water may be further performed before performing the pulverizing process.

The pulverizing process may be performed using a homogenizer, and may be performed at about 5000 rpm to about 14,000 rpm for about 2 minutes to about 10 minutes. When the pulverizing process is performed at the above speed and time, a gel having a suitable or desired size may be appropriately or suitably obtained.

The ultrasonic wave process may be performed with power of about 5 W to about 30 W for about 1 minute to about 5 minutes. When the ultrasonic wave process is performed under the above conditions, dissolution of the material to be used can be minimized or reduced and the size of the gel can be reduced, so that a gel with an appropriate or suitable size may be formed.

The filtration process may be performed through syringe filtering, thereby obtaining a microgel in which a suitable or desired size is substantially uniformly distributed.

The prepared microgel may include the acryl-based polymer in an amount of about 5 volume % or less, and about 0.1 volume % or more, and water in an amount of about 95 volume % or more, and about 99.9 volume % or less. In addition, the prepared microgel may have a size of about 0.5 pm to about 5 pm. In the process of preparing the negative electrode using the microgel, water may be removed, and a substantially solid microgel including the acryl-based polymer may exist in the negative active material layer. In addition, because the microgel existing in the negative active material layer is contracted after removing water, the size of the microgel may be about 500 nm or less, for example, about 50 nm to about 500 nm.

In a drying process of the preparation of the negative electrode, water may be removed from the microgel including about 95 volume % or more and about 99.9 volume % or less of water to form pores in the negative active material layer, and the volume of the microgel may be reduced such that the microgel in the final negative active material layer may have a size of about 500 nm or less. In addition, the formed pores may be partially removed during the pressurizing process, and a negative active material layer having a porosity of about 20% to about 60%, and in one or more embodiments, a porosity of about 20% to about 40% may be finally obtained, the microgel may be present in the final negative active material layer in a shape not substantially spherical but somewhat distorted, having a size of about 500 nm or less.

As described above, the negative electrode according to one or more embodiments is prepared by separately adding the microgel during the preparation of the negative electrode and this may allow the microgel to be totally uniformly distributed and present in the negative active material layer, rather than forming the microgel during the negative electrode preparation by using a material being capable of forming a microgel in the negative electrode preparation. Accordingly, the negative electrode having the negative active material layer having appropriate or suitable porosity may be prepared by using the microgel, and an effect of improving charge at high rates may be obtained by including the microgel.

The rechargeable lithium battery according to one or more embodiments includes a positive electrode and an electrolyte together with the negative electrode.

The positive electrode includes a current collector and a positive electrode active material layer on the current collector.

The positive electrode active material may include compounds capable of reversibly intercalating and deintercalating lithium (lithiated intercalation compounds). For example, one or more composite oxides of lithium and metals selected from cobalt, manganese, nickel, and combinations thereof may be used. In some embodiments, compounds represented by one selected from the following chemical formulas may be used. LiₐA_{1-b}X_{b}D₂(0.90≤a≤1.8, 0≤b≤0.5); LiₐA_{1-b}X_{b}O_{2-c}D_{c}(0.90≤a≤1.8, 0≤b≤0.5, 0≤c≤0.05; LiₐE_{1-b}X_{b}O_{2-c}D_{c}(0.90≤a≤1.8, 0≤b≤0.5, 0≤c≤0.05); LiₐE_{2-b}X_{b}O_{4-c}D_{c}(0.90≤a≤1.8, 0≤b≤0.5, 0≤c≤0.05); LiₐNi_{1-b-c}Co_{b}X_{c}D_{α}(0.90≤a≤1.8, 0≤b≤0.5, 0≤c≤0.5, 0<α≤2); LiₐNi_{1-b-c}Co_{b}X_{c}O_{2-α}T_{α}(0.90≤a≤1.8, 0≤b≤0.5, 0≤c≤0.5, 0<α<2); LiₐNi_{1-b-c}Mn_{b}X_{c}D_{α}(0.90≤a≤1.8, 0≤b≤0.5, 0≤c≤0.5, 0<α2); LiₐNi_{1-b-c}Mn_{b}X_{c}O_{2-α}T_{α}(0.90≤a≤1.8, 0≤b≤0.5, 0≤c≤0.5, 0<α2); LiₐNi_{1-b-c}Mn_{b}X_{c}O_{2-α}T₂(0.90≤a≤1.8, 0≤b≤0.5, 0≤c≤0.5, 0<α<2); LiₐNi_{b}E_{c}G_{d}O₂(0.90≤a≤1.8, 0≤b≤0.9, 0≤c≤0.5, 0.001≤d≤0.1); LiₐNi_{b}Co_{c}Mn_{d}GₑO₂(0.90≤a≤1.8, 0≤b≤0.9, 0≤c≤0.5, 0≤d≤0.5, 0≤e≤0.1); LiₐNi_{b}Co_{c}Al_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≥0.1); LiₐMn_{1-g}G_{g}PO₄(0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2); Li_{(3-f)}Fe₂(PO₄)₃(0≤f≤2); LiₐFePO₄(0.90≤a≤1.8)

In the above chemical formulas, A is selected from Ni, Co, Mn, or combinations thereof; X is selected from Al, Ni, Co, Mn, Cr, Fe, Mg, Sr, V, rare earth elements, or combinations thereof; D is selected from O, F, S, P, or combinations thereof; E is selected from Co, Mn, or combinations thereof; T is selected from F, S, P, or combinations; G is selected from Al, Cr, Mn, Fe, Mg, La, Ce, Sr, V, or combinations thereof; Q is selected from Ti, MO, Mn, or combinations thereof; Z is selected from Cr, V, Fe, Sc, Y, or combinations thereof; J is selected from V, Cr, Mn, Co, Ni, Cu, or combinations thereof.

Also, the compounds may have a coating layer on the surface, or may be mixed together with another compound having the coating layer. The coating layer may include at least one coating element compound selected from the group consisting of an oxide of a coating element, a hydroxide of the coating element, an oxyhydroxide of the coating element, an oxycarbonate of the coating element, and a hydroxyl carbonate of the coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be coated utilizing a method having no (or substantially no) adverse influence on properties of a positive electrode active material by using these elements in the compound, and for example, the method may include any suitable coating method such as spray coating, dipping, and/or the like, but is not illustrated in more detail because it would be readily understood by a person of ordinary skill in the art upon reviewing this disclosure.

In the positive electrode, the positive active material layer may include about 90 wt % to about 98 wt % of the positive active material based on the total weight of the positive active material layer.

In an embodiment, the positive electrode active material layer may further include a binder and a conductive material (e.g., an electrically conductive material). Herein, the positive active material layer may include about 1 wt % to about 5 wt % of the binder and the conductive material based on the total weight of the positive active material layer.

The binder improves binding properties of positive electrode active material particles with one another and with a current collector. Examples thereof may include polyvinyl alcohol, carboxymethyl cellulose, hydroxypropyl cellulose, diacetyl cellulose, poly vinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene butadiene rubber, acrylated styrene-butadiene rubber, epoxy resin, nylon, and the like, but the present disclosure is not limited thereto.

The conductive material is included to provide electrode conductivity (e.g., electrical conductivity), and any suitable electrically conductive material may be used as a conductive material unless it causes a chemical change (e.g., an undesirable chemical change in the rechargeable lithium battery). For example, the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer (e.g., an electrically conductive polymer) such as a polyphenylene derivative; or a mixture thereof.

The current collector may include Al, but the present disclosure is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone, and/or the like. In addition, the alcohol-based solvent may include ethyl alcohol, isopropyl alcohol, and/or the like. The aprotic solvent may include nitriles such as R-CN (where R is a C2 to C20 linear, branched, or cyclic hydrocarbon, and may include a double bond, an aromatic ring, and/or an ether bond), amides such as dimethylformamide, dioxolanes such as 1,3-dioxolane, sulfolanes, and/or the like.

The organic solvent may be used singularly or in a mixture. When the organic solvent is used in a mixture, the mixture ratio may be controlled in accordance with a suitable or desirable battery performance and it would be readily understood by a person of ordinary skill in the art upon reviewing this disclosure.

Herein, when a mixture of a cyclic carbonate and a linear carbonate, or a mixture of a cyclic carbonate and a propionate-based solvent is used, it may be suitable or desirable to use it with a volume ratio of about 1:1 to about 1:9 considering the performance of the rechargeable lithium battery.

The organic solvent may further include an aromatic hydrocarbon-based solvent as well as the carbonate-based solvent. Herein, the carbonate-based solvent and the aromatic hydrocarbon-based solvent may be mixed together in a volume ratio of 1:1 to 30:1.

The aromatic hydrocarbon-based organic solvent may be an aromatic hydrocarbon-based compound represented by Chemical Formula 1:

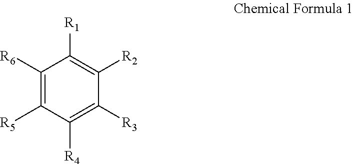

wherein R₁ to R₆ are the same as or different from each other, and are selected from hydrogen, a halogen, a C1 to C10 alkyl, a C1 to C10 haloalkyl, or combinations thereof.

The aromatic hydrocarbon-based organic solvent may include, but is not limited to, benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or combinations thereof.

The electrolyte may further include vinylethyl carbonate, vinylene carbonate, and/or an ethylene carbonate-based compound of Chemical Formula 2 to improve the battery cycle-life:

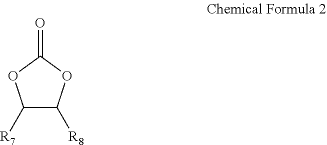

wherein, R₇ and R₈ are the same as or different from each other, and are independently selected from the group consisting of hydrogen, a halogen group, a cyano group (CN), a nitro group (NO₂), or a C1 to C5 fluoroalkyl group, and at least one selected from R₇ and R₈ is selected from the group consisting of a halogen group, a cyano group (CN), a nitro group (NO), or a C1 to C5 fluoroalkyl group, but R₇ and R₈ are not simultaneously hydrogen.

Examples of the ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate, or fluoroethylene carbonate, and/or the like. When these cycle-life improving additives are further used, the use amounts thereof may be appropriately or suitably controlled.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salts selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CxF₂ₓ₊₁SO₂)(CyF_{2y+1}SO₂)(where, x and y are natural numbers, for example, are integers of about 1 to about 20), lithium difluoro(bisoxalato) phosphate, LiCl, Lil, LiB(C₂O₄)₂ (lithium bis(oxalato) borate: LiBOB), and lithium difluoro(oxalato) borate (LiDFOB). The concentration of the lithium salt may be suitably or desirably a range of about 0.1 M to about 2.0 M. When the lithium salt is included at the above concentration range, an electrolyte may have excellent performance and lithium ion mobility due to suitable or optimal electrolyte conductivity (e.g., electrical conductivity) and viscosity.

A separator may be between the positive electrode and the negative electrode depending on a type or kind of a rechargeable lithium battery. As for the separator, polyethylene, polypropylene, polyvinylidene fluoride or multi-layers of two or more layers thereof may be used. Mixed multi-layers thereof such as a polyethylene/polypropylene double-layered separator, a polyethylene/polypropylene/polyethylene triple-layered separator, polypropylene/polyethylene/polypropylene triple-layered separator, and/or the like may be used.

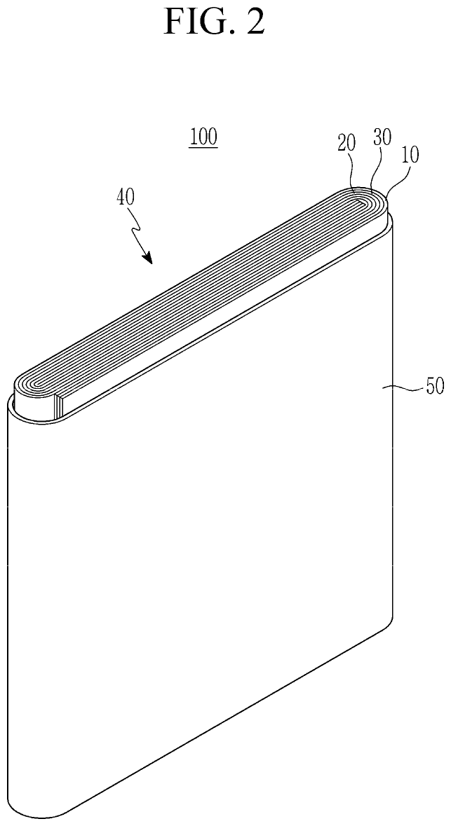

FIG. 2 is an exploded perspective view of a rechargeable lithium battery according to one or more embodiments. The rechargeable lithium battery according to an embodiment is illustrated as a prismatic battery, but the present disclosure is not limited thereto, and may include various suitable types or kinds of batteries such as a cylindrical battery, a pouch battery, and/or the like.

Referring to FIG. 2, a rechargeable lithium battery 100 according to one or more embodiments may include an electrode assembly 40 wound with a separator 30 interposed between a positive electrode 10 and a negative electrode 20, and a case 50 housing the electrode assembly 40. The positive electrode 10, the negative electrode 20, and the separator 30 may be impregnated with an electrolyte.

Hereinafter, example embodiments and comparative examples of the present disclosure will be described in more detail. The following example embodiments are only embodiments of the present disclosure, and this disclosure is not limited to the following embodiments.

### Preparation Example 1: Preparation of Microgel

0.5 g of acrylic acid, 0.1 g of N,N′-methylenebisacrylamide, 0.2 g of sodium hydroxide, and 0.04 g of ammonium persulfate were added to 10 g of water and mixed together to prepare a mixed solution.

0.1 g of tetramethylenediamine was added to the mixed solution and mixed.

The obtained product was reacted for 2 hours to gel, and the obtained gel was washed with distilled water for 3 days. The washed gel was pulverized at a speed of 14,000 rpm for 2 hours using a homogenizer. The obtained pulverized product was ultrasonic wave treated with 25 W of power for 2 minutes, and then syringe filtrated to prepare a microgel having an average size (average particle diameter, D50) of 5000 nm.

### Example 1

A negative active material slurry was prepared by mixing together 96.95 wt % of artificial graphite, 0.05 wt % of the microgel prepared in Preparation Example 1, 0.5 wt % of a denka black conductive material, 0.8 wt % of a styrene-butadiene rubber binder, and 1.7 wt % of a carboxymethyl cellulose thickener in a water solvent.

A negative electrode including a Cu foil current collector and a negative active material layer on the current collector was prepared by a general technique including coating the negative active material slurry on the Cu foil current collector, drying and pressurizing. The average size (particle diameter, D50) of the microgel included in the prepared negative electrode was 500 nm.

A coin-type half-cell was fabricated using the negative electrode, a lithium metal counter electrode and an electrolyte. The electrolyte was prepared by adding 1 wt % of vinylene carbonate and 1 wt % of methyl propionate to 100 wt % of a mixed solvent of ethylene carbonate, ethylmethyl carbonate, and dimethyl carbonate (20:40:40 volume ratio) in which 1.15 M of LiPF₆ was dissolved.

### Example 2

A negative electrode and a half-cell were prepared in substantially the same method as in Example 1, except that a negative active material slurry was prepared by mixing together 96.9 wt % of artificial graphite, 0.1 wt % of the microgel prepared in Preparation Example 1, 0.5 wt % of a denka black conductive material, 0.8 wt % of a styrene-butadiene rubber binder, and 1.7 wt % of a carboxymethyl cellulose thickener in a water solvent.

### Comparative Example 1

A negative electrode and a half-cell were prepared in substantially the same method as in Example 1, except that a negative active material slurry was prepared by mixing together 97 wt % of artificial graphite, 0.5 wt % of a denka black conductive material, 0.8 wt % of a styrene-butadiene rubber binder, and 1.7 wt % of a carboxymethyl cellulose thickener in a water solvent.

### Reference Example 1

A negative electrode and a half-cell were prepared in substantially the same method as in Example 1, except that a negative active material slurry was prepared by mixing together 96.7 wt % of artificial graphite, 0.3 wt % of the microgel prepared in Preparation Example 1, 0.5 wt % of a denka black conductive material, 0.8 wt % of a styrene-butadiene rubber binder, and 1.7 wt % of a carboxymethyl cellulose thickener in a water solvent.

### Experimental Example 1) SEM Measurement

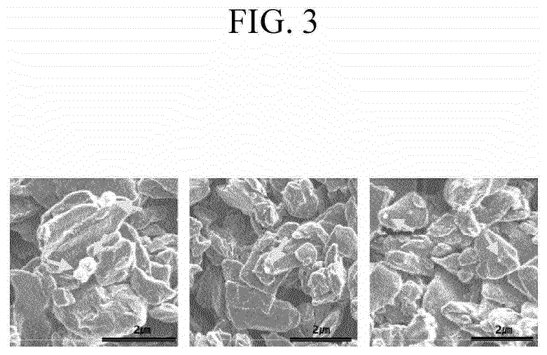

FIG. 3 illustrates a SEM image of the negative active material layer prepared according to Example 2. In FIG. 3, arrows point to microgels that exist in the form of particles. It may be clearly seen in FIG. 3 that the microgel in the form of particles is present in the negative active material layer. In addition, it can be seen that the size of the microgel is 500 nm or less.

### Experimental Example 2) Measurement of Porosimetry, Porosity, and BET Specific Surface Area

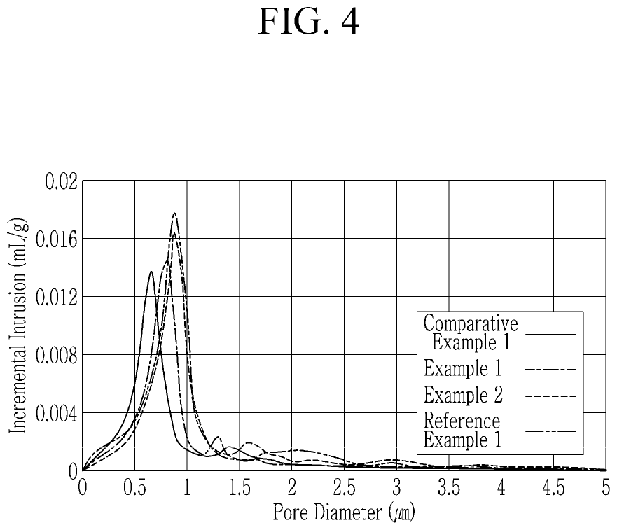

The pore sizes of the negative active material layers prepared in Example 1 and 2, Comparative Example 1, and Reference Example 1 were measured by a mercury intrusion porosimetry analyzer. The mercury incremental intrusions according to the pore size are shown in FIG. 4.

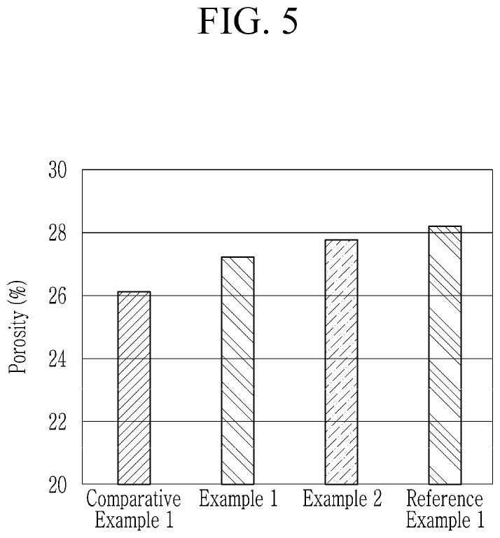

In addition, the porosity of the negative active material layer prepared in Examples 1 and 2, Comparative Example 1, and Reference Example 1 was measured by a mercury intrusion porosimetry analyzer. The results are shown in Table 1 and FIG. 5.

As shown in FIG. 4, pores formed in the negative active material layer of Example 2 mainly included pores of about 1.2 μm, but in Comparative Example 1, pores of about 0.7 μm are mainly included, and thus, it can be seen that the pore volume of Example 1 is significantly increased relative to Comparative Example 1.

In addition, as shown in Table 1 and FIG. 5, the porosity of Example 1 is about 27.3%, and the porosity of Example 2 is about 27.8%, which are higher than about 26% of Comparative Example 1.

From this result, it may be predicted that use of a microgel in a negative electrode preparation allows for largely forming large pores, that is, to increase a pore volume, and thus, the effect of electrolyte solution impregnation will increase.

TABLE 1

| | Microgel amount | Porosity |
|---|---|---|
| | (wt %) | (%) |
| Comparative | 0 | 26.17024 |
| Example 1 | | |
| Example 1 | 0.05 | 27.23065 |
| Example 2 | 0.1 | 27.80027 |
| Reference | 0.3 | 28.24245 |
| Example 1 | | |

In addition, the Brunauer-Emmett-Teller (BET) surface areas of the negative active material layers prepared in Example 1 and Comparative Example 1 were measured. The results thereof are shown in Table 2 below.

TABLE 2

| | BET surface area (m²/g) |
|---|---|
| Comparative | 6.44 |
| Exmaple 1 | |
| Example 1 | 6.53 |

As shown in Table 2, the BET surface area of Example 1 is higher than that of Comparative Example 1, which is considered to be due to the high pore volume and porosity as shown in FIGS. 4 and 5, and Table 1, as the microgel is included.

### Experimental Example 3) Evaluation of Charging Rate Characteristics

Constant current and constant voltage charging rates of the half-cells prepared according to Examples 1 and 2, Comparative Example 1, and Reference Example 1 were measured by the following method.

0.33 C, 4.2 V, 0.05 C cut-off charging and 0.33 C, 3.1 V cut-off discharging/0.5 C, 4.2 V, 0.05 C cut-off charging/0.33 C, 3.1 V cut-off discharging/1 C, 4.2 V, 0.05 C cut-off charging/1.5 C, 4.2, 0.05 C cut-off charging and 0.03 C, 3.1 V cut-off discharging/2C, 4.2 V, 0.05 C cut-off charging and 0.33 C, 3.1 V cut-off discharging/and 4 C, 4.2 V, 0.05 C cut-off charging and 0.33 C, 3.1 V cut-off discharging were performed for the half-cells once, respectively. At this time, all charging was performed under constant current-constant voltage conditions, and discharging was performed under constant current conditions.

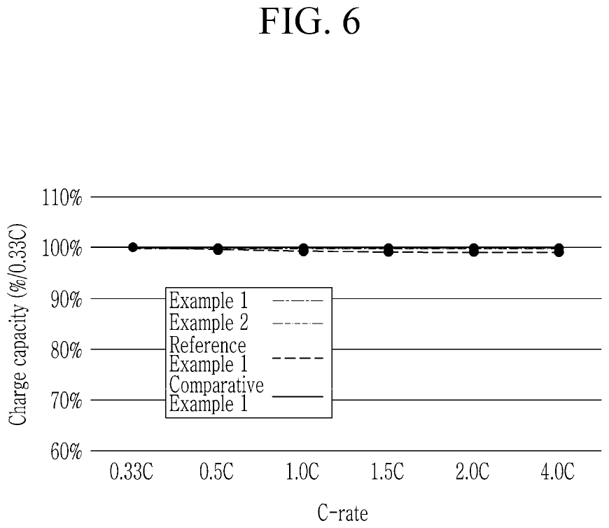

The charge capacity was measured at each rate, and the charge capacity ratio of each rate to the 0.33 C charge capacity was obtained. The results are shown in FIG. 6.

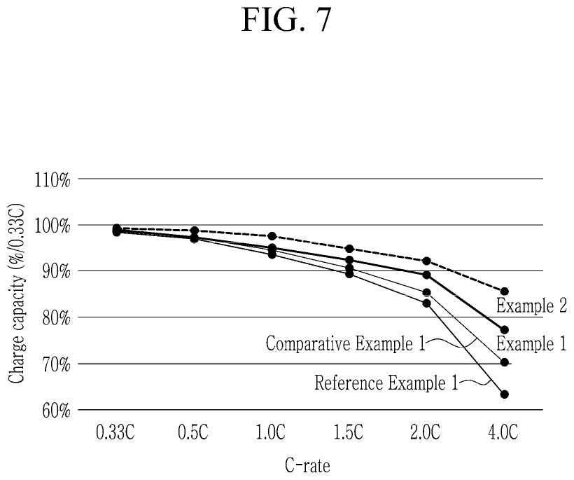

Constant current charging experiment was performed by setting charging and discharging conditions in substantially the same conditions as the constant current and constant voltage charging rate experiments, but charging and discharging were performed in both constant current conditions. The charge capacity was measured at each rate, and the charge capacity ratio of each rate to the 0.33 C charge capacity was obtained, and the results are shown in FIG. 7.

As shown in FIG. 6, it can be seen that the constant current and constant voltage charging rates show a similar level of rate charging capacity ratio regardless of whether or not a microgel is included, or whether or not the microgel was used in an excessive amount.

In contrast, as shown in FIG. 7, it can be seen that in the case of Examples 1 and 2 including a microgel, 0.05 wt % and 0.1 wt % of microgel, respectively, as described above, the pore volume and porosity are high, thereby showing an excellent high-rate charging rate, and, for example, showing a high-rate charging rate as compared with Comparative Example 1 in which no microgel is used. It can be seen that in the case of Reference Example 1 in which an excessive amount of the microgel is used in an amount of 0.3 wt %, the high-rate charging rate is rather degraded.

The effects from inclusion of the microgel at an appropriate amount may be clearly shown from the results of Table 3, which shows the 4 C constant current charging capacity ratio to the 0.33 C constant current charging capacity among the results of FIG. 7.

TABLE 3

| | Microgel | 4 C constant current charge capacity |
|---|---|---|
| | amount | (to 0.33 C constant current charge |
| | (wt %) | capacity, %) |
| Comparative | 0 | 70.4 |
| Exmaple 1 | | |
| Example 1 | 0.05 | 77.3 |
| Example 2 | 0.1 | 85.6 |
| Reference | 0.3 | 63.4 |
| Example 1 | | |

### Experimental Example 4) Evaluation of Cycle-life Characteristics

The half-cells according to Examples 1 and 2, Comparative Example 1, and Reference Example 1 were charged at 1 C, 4.2 V, 0.05 C cut-off under constant current-constant voltage conditions, and discharged at 1 C, 3.1 V cut-off under constant current conditions at room temperature (25° C.). The charging and discharging were performed 100 times.

A ratio of discharging capacity at each cycle to discharge capacity at the first cycle was calculated. The results are shown in Table 4 as a capacity retention.

TABLE 4

| | Microgel amount | Capacity Retention |
|---|---|---|
| | (wt %) | (%) |
| Comparative | 0 | 93.0 |
| Exmaple 1 | | |
| Example 1 | 0.05 | 93.0 |
| Example 2 | 0.1 | 93.7 |
| Reference | 0.3 | 92.3 |
| Example 1 | | |

As shown in Table 4, it can be seen that an appropriate capacity retention is maintained when the microgel is included in an amount of 0.1 wt % or less based on the total weight 100 wt % of the negative active material layer. In this regard, it can be seen that when an excessive amount of the microgel is included (Reference Example 1), the capacity retention is degraded even if the microgel is included.

### Experimental Example 5) Measurement of Electrochemical Impedance Spectroscopy (EIS)

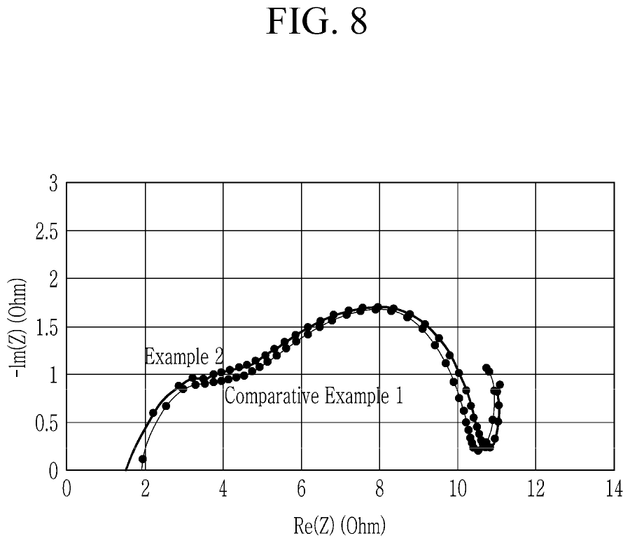

The half-cells according to Example 2 and Comparative Example 1 were charged with SOC (State of Charge) 100% (full charge, a battery cell was charged to have 100% of charge capacity based on 100% of the entire charge capacity of the battery cell during the charge and discharge at 2.75 V to 4.4 V) at 0.7 C, and then EIS was measured using a signal of 3 mV in a frequency range of 10 kHz to 1 mHz. The results are shown in FIG. 8.

As shown in FIG. 8, in the case of Example 2, which included the microgel, it can be seen that bulk resistance (Rs) was slightly decreased and charge transfer resistance (Rct) was slightly increased, compared to Comparative Example 1 which did not include the microgel. For example, it can be seen that there is substantially little increase in resistance.

While the subject matter of this disclosure has been described in connection with what are presently considered to be practical exemplary embodiments, it is to be understood that the present disclosure is not limited to the disclosed embodiments. On the contrary, it is intended to cover various modifications and equivalent arrangements included within the spirit and scope of the appended claims, and equivalents thereof.

What is claimed is:

1. A negative electrode for a rechargeable lithium battery, comprising:
a current collector; and
a negative active material layer on at least one surface of the current collector,
wherein the negative active material layer comprises a negative active material and a microgel having a size of about 500 nm or less, and having a porosity of about 27% to about 60%.

2. The negative electrode for the rechargeable lithium battery of claim 1, wherein the size of the microgel is about 50 nm to about 500 nm.

3. The negative electrode for the rechargeable lithium battery of claim 1, wherein the microgel is in the form of a particle.

4. The negative electrode for the rechargeable lithium battery of claim 1, wherein the microgel comprises an acryl-based polymer.

5. The negative electrode for the rechargeable lithium battery of claim 1, wherein the negative active material layer comprises about 0.1 wt % or less of the microgel based on the total weight of 100 wt % of the negative active material layer.

6. The negative electrode for the rechargeable lithium battery of claim 1, wherein the negative active material layer comprises about 0.05 wt % to about 0.1 wt % of the microgel based on the total weight of 100 wt % of the negative active material layer.

7. A rechargeable lithium battery, comprising:
a negative electrode of claim 1;
a positive electrode; and
an electrolyte.
